(19) United States
(12) Patent Application Publication
(10) Pub. No.: US 2012/0117514 A1
(43) Pub. Date: May 10, 2012

(54) Three-Dimensional User Interaction

(75) Inventors: David Kim, Cambridge (GB); Otmar Hilliges, Cambridge (GB); Shahram Izadi, Cambridge (GB); David Molyneaux, Oldham (GB); Stephen Edward Hodges, Cambridge (GB)

(73) Assignee: Microsoft Corporation, Redmond, WA (US)

(21) Appl. No.: 12/939,891

(22) Filed: Nov. 4, 2010

(51) Int. Cl. G06F 3/048; G06F 3/033

(52) U.S. Cl. 715/849; 345/158

(57) ABSTRACT

Three-dimensional user interaction is described. In one example, a virtual environment having virtual objects and a virtual representation of a user's hand with digits formed from jointed portions is generated, a point on each digit of the user's hand is tracked, and the virtual representation's digits controlled to correspond to those of the user. An algorithm is used to calculate positions for the jointed portions, and the physical forces acting between the virtual representation and objects are simulated. In another example, an interactive computer graphics system comprises a processor that generates the virtual environment, a display device that displays the virtual objects, and a camera that capture images of the user's hand. The processor uses the images to track the user's digits, computes the algorithm, and controls the display device to update the virtual objects on the display device by simulating the physical forces.

Modern computing hardware and software enables the creation of rich, realistic 3D virtual environments. Such 3D virtual environments are widely used for gaming, education/training, prototyping, and any other application where a realistic virtual representation of the real world is useful. To enhance the realism of these 3D virtual environments, physics simulations are used to control the behavior of virtual objects in a way that resembles how such objects would behave in the real world under the influence of Newtonian forces. This enables their behavior to be predictable and familiar to a user.

It is, however, difficult to enable a user to interact with these 3D virtual environments. Most interactions with 3D virtual environments happen via indirect input devices such as mice, keyboards or joysticks. Other, more direct input paradigms have been explored as means to manipulate virtual objects in such virtual environments. Among them is pen-based input control, and also input from vision-based multi-touch interactive surfaces. However, in such instances there is the mismatch of input and output. Pen-based and multi-touch input data is inherently 2D which makes many interactions with the 3D virtual environments difficult if not impossible. For example, the grasping of objects to lift them or to put objects into containers etc. cannot be readily performed using 2D inputs.

An improved form of 3D interaction is to track the pose and posture of the user's hand entirely in 3D and then insert a deformable 3D mesh representation of the users hand into the virtual environment. However, this technique is computationally very demanding, and inserting a mesh representation of the user's hand into the 3D virtual environment and updating it in real-time exceeds current computational limits. Furthermore, tracking of the user's hand using imaging techniques suffers from issues with occlusion (often self-occlusion) of the hand, due to limited visibility of large parts of the hand in certain postures, which leads to unreliable and unpredictable interaction results in the 3D virtual environment.

The embodiments described below are not limited to implementations which solve any or all of the disadvantages of known 3D virtual environments.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Three-dimensional user interaction is described. In one example, a virtual environment having virtual objects and a virtual representation of a user's hand with digits formed from jointed portions is generated, a point on each digit of the user's hand is tracked, and the virtual representation's digits controlled to correspond to those of the user. An algorithm is used to calculate positions for the jointed portions, and the physical forces acting between the virtual representation and objects are simulated. In another example, an interactive computer graphics system comprises a processor that generates the virtual environment, a display device that displays the virtual objects, and a camera that capture images of the user's hand. The processor uses the images to track the user's digits, computes the algorithm, and controls the display device to update the virtual objects on the display device by simulating the physical forces.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an interactive 3D computer graphics system;

FIG. 2 illustrates a flowchart of a process for 3D user interaction;

FIG. 3 illustrates a set of tracked points on a user's hand;

FIG. 4 illustrates a 3D virtual environment;

FIG. 5 illustrates a flowchart of a process for training a random decision forest to track points on a user's hand;

FIG. 6 illustrates an example decision forest;

FIG. 7 illustrates a flowchart of a process for classifying points on a user's hand;

FIG. 8 illustrates an example augmented reality system using the 3D user interaction technique; and

FIG. 9 illustrates an exemplary computing-based device in which embodiments of the 3D user interaction technique may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a desktop computing system, the system described is provided as an example and not a limitation. As those skilled in the art will appreciate, the present examples are suitable for application in a variety of different types of computing systems, such as mobile systems and dedicated virtual and augmented reality systems.

Described herein is a technique for enabling 3D interaction between a user and a 3D virtual environment in a manner that is computationally efficient, yet still allows for natural and realistic interaction. The user can use their hand in a natural way to interact with virtual objects by grasping, scooping, lifting, pushing, and pulling objects. This is much more intuitive than the use of a pen, mouse, or joystick. This is achieved by inserting a virtual model or representation of the user's hand into the virtual environment, which mirrors the actions of the user's real hand. To reduce the computational complexity, only a small number of points on the user's real hand are tracked, and the behavior of the rest of the virtual model or representation are interpolated from this small number of tracked points using an inverse kinematics algorithm. A simulation of physical forces acting between the virtual hand representation and the virtual objects ensures rich, predictable, and realistic interaction.

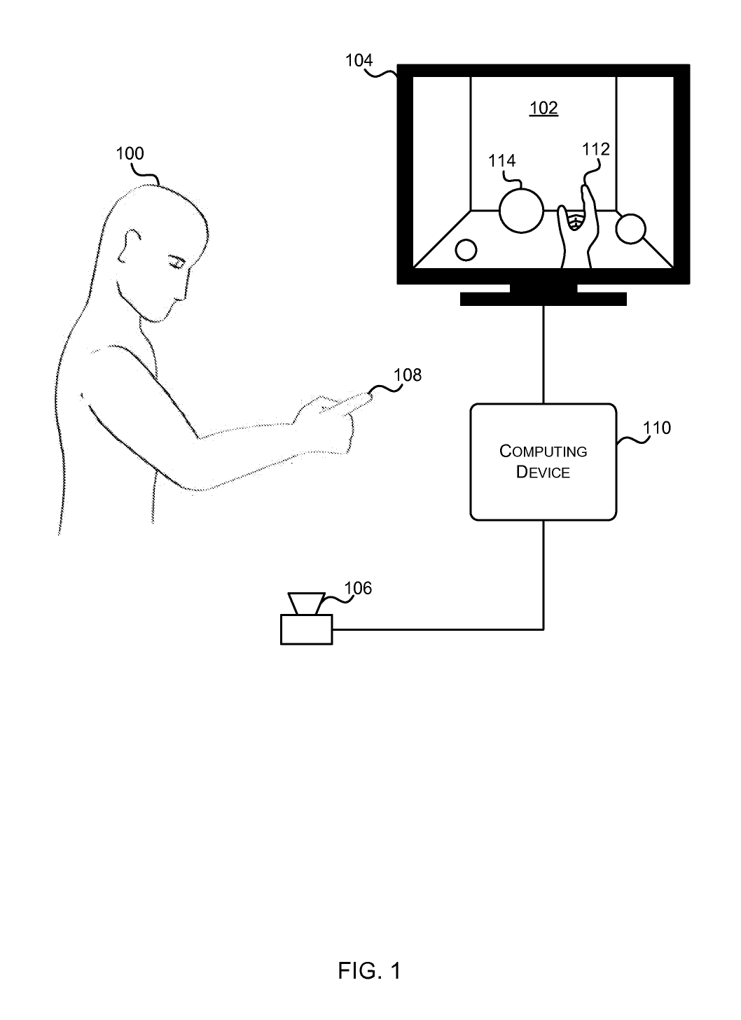

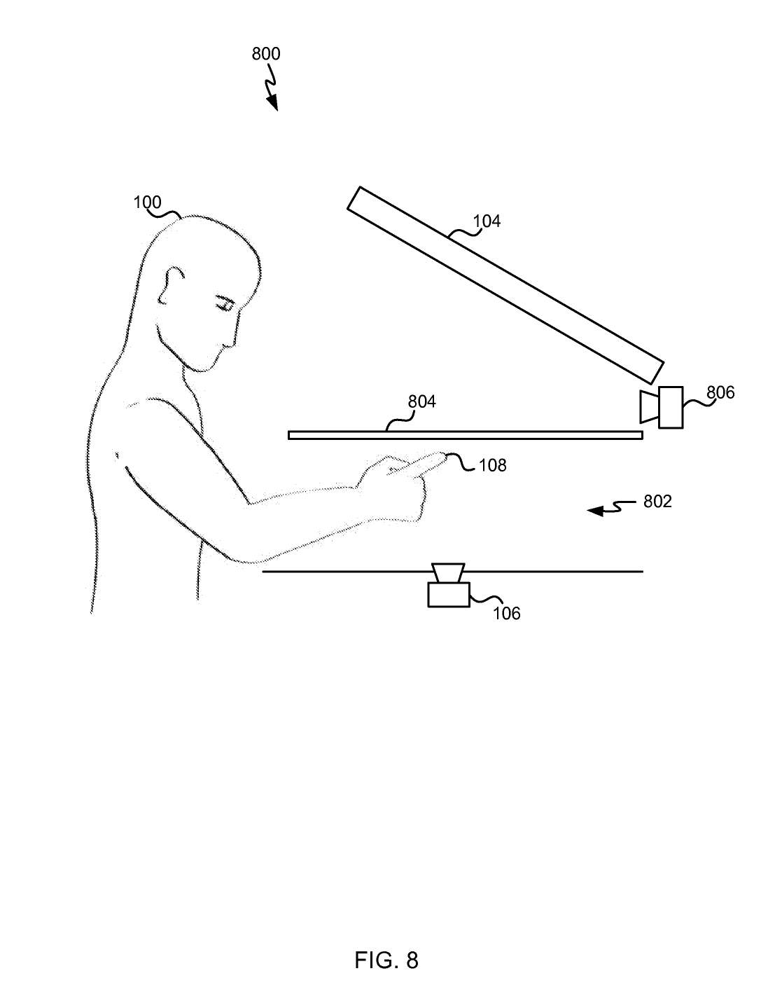

Reference is first made to FIG. 1, which illustrates an interactive 3D computer graphics system. FIG. 1 shows a user 100 interacting with a 3D virtual environment 102 which is displayed on a display device 104. The display device 104 can, for example, be a regular computer display, such as a liquid crystal display (LCD) or organic light emitting diode (OLED) panel (which may be a transparent OLED display), or a stereoscopic, autostereoscopic, or volumetric display. The use of a stereoscopic, autostereoscopic or volumetric display enhances the realism of the 3D environment by enhancing the appearance of depth in the 3D virtual environment 102. In other examples, the display device 104 can be in a different form, such as head-mounted display (for use with either augmented or virtual reality), a projector, or as part of a dedicated augmented/virtual reality system (such as the example augmented reality system described below with reference to FIG. 8).

A camera 106 is arranged to capture images of the user's hand 108. In one example, the camera 106 is a depth camera (also known as a z-camera), which generates both intensity/color values and a depth value (i.e. distance from the camera) for each pixel in the images captured by the camera. The depth camera can be in the form of a time-of-flight camera, stereo camera or a regular camera combined with a structured light emitter. The use of a depth camera enables three-dimensional information about the position, movement, size and orientation of the user's hand 108 to be determined. In some examples, a plurality of depth cameras can be located at different positions, in order to avoid occlusion when multiple hands are present, and enable accurate tracking to be maintained.

In other examples, a regular 2D camera can be used to track the 2D position, posture and movement of the user's hand 108, in the two dimensions visible to the camera. A plurality of regular 2D cameras can be used, e.g. at different positions, to derive 3D information on the user's hand 108.

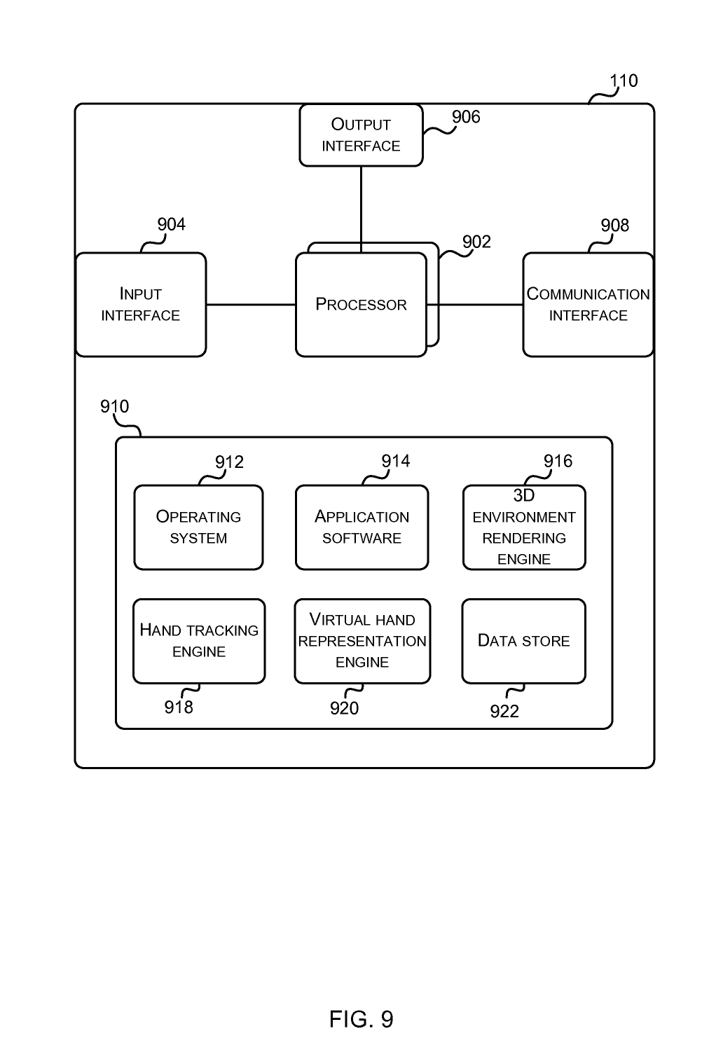

The camera provides the captured images of the user's hand 108 to a computing device 110. The computing device 110 is arranged to use the captured images to track the user's hand 108, and determine the locations of various points on the hand, as outlined in more detail below. The computing device 110 uses this information to generate a virtual representation 112 of the user's hand 108, which is inserted into the virtual environment 102 (the computing device 110 can also generate the virtual environment). The computing device 110 determines the interaction of the virtual representation 112 with one or more virtual objects 114 present in the virtual environment 102, as outlined in more detail below. Details on the structure of the computing device are discussed with reference to FIG. 9.

Note that, in other examples, the user's hand 108 can be tracked without using the camera 106. For example, a wearable position sensing device, such as a data glove, can be worn by the user, which comprises sensors arranged to determine the position of the digits of the user's hand 108, and provide this data to the computing device 110.

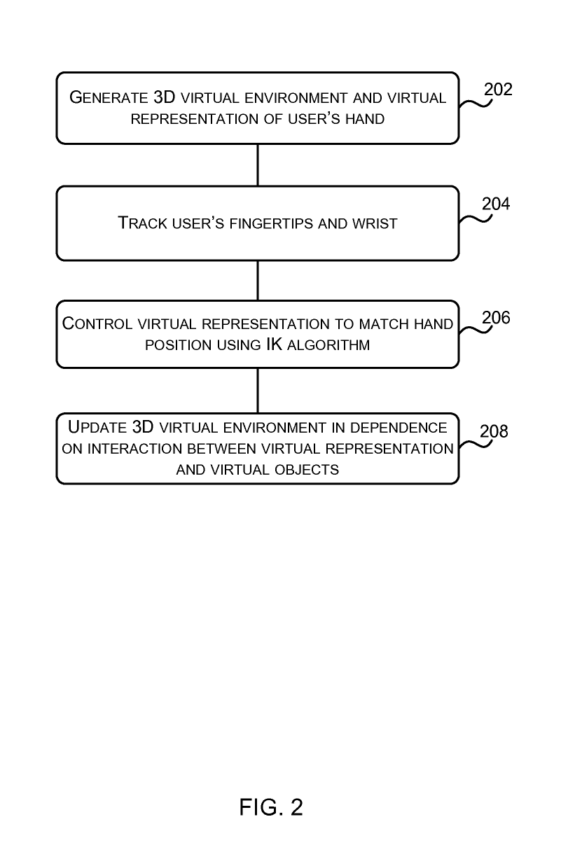

Reference is now made to FIG. 2, which illustrates a flowchart of a process for 3D user interaction in system such as that shown in FIG. 1. The computing device 110 (or a processor within the computing device 110) generates 202 the 3D virtual environment 102 that the user 100 is to interact with. The virtual environment 102 can be any type of 3D scene that the user can interact with. For example, the virtual environment 102 can comprise virtual objects such as prototypes/models, blocks, spheres or other shapes, buttons, levers or other controls.

The computing device 110 also generates the virtual representation 112 of the user's hand 108. The virtual representation 112 of the user's hand 108 can be in the form of a skeletal approximation of the user's real hand. The virtual representation 112 comprises a plurality of virtual digits that are formed from a plurality of jointed portions (i.e. portions connected by movable joints), in a similar manner to the digits of a real hand. The virtual representation 112 can be displayed in the virtual environment 102 in simple wire-frame form (e.g. showing the jointed portions), or rendered to look realistic.

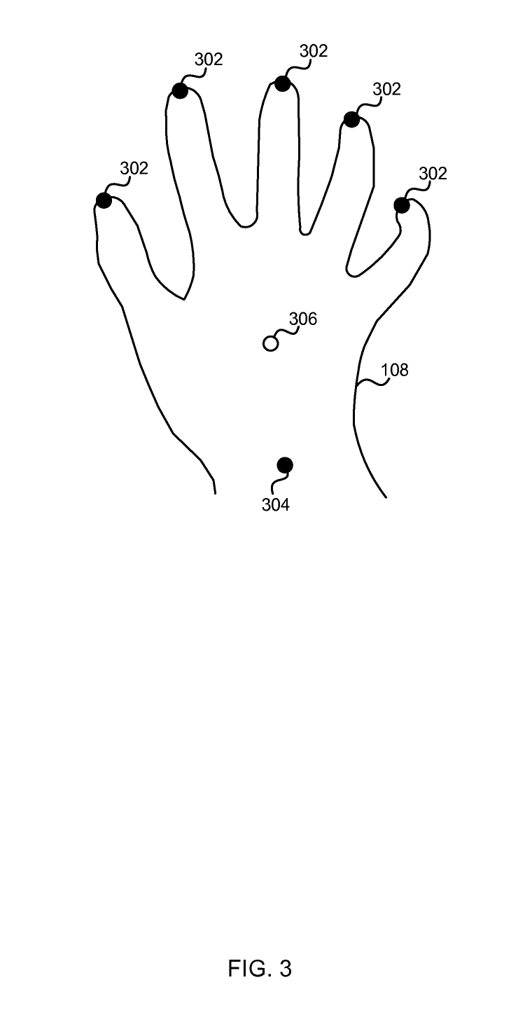

To enable interaction, the computing device 110 tracks 204 the position of a plurality of points on the user's hand 108. This is performed by analyzing the images provided by the camera 106 as outlined in detail below, or input from the data-glove. The computing device 110 tracks the location of a point on each of the digits of the user's hand 106, such as the fingertips. This is illustrated with reference to FIG. 3, which shows the user's hand 108 and the fingertip point 302 on each digit. In other examples, a different part of each digit can be tracked, such as a fingernail, or a selected joint or knuckle.

In order to improve the accuracy and alignment of the virtual representation 112, at least one further point on the user's hand is also tracked. This can be, for example, a wrist point 304 and/or a palm point 306 as shown in FIG. 3. The five points on the digits plus the further point on the hand form a set of point locations that the computing device 110 tracks, and subsequently uses to control the virtual representation 112 of the hand.

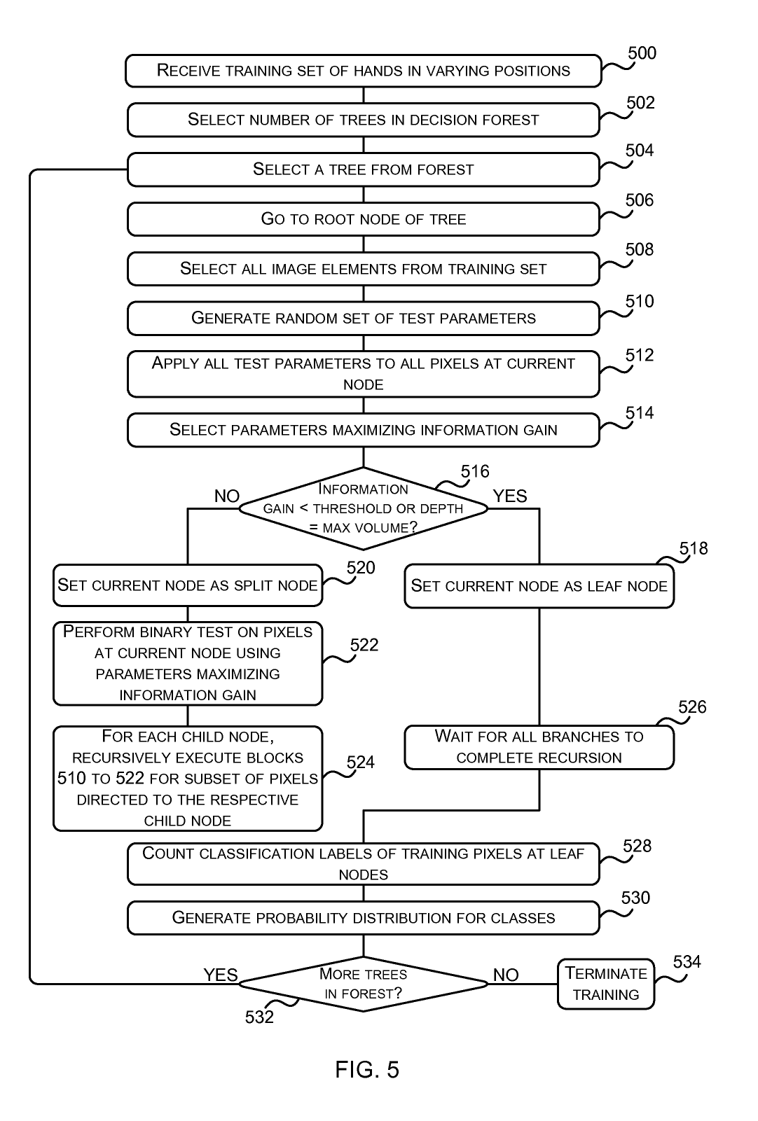

The computing device 110 tracks set of point locations by analyzing each captured image of the user's hand 108, and determining the position of each point location. If the camera 106 is a depth camera (or an equivalent arrangement of 2D cameras), then the set of point locations can be tracked in three dimensions. In one example, the set of point locations can be determined by using a machine learning classifier to classify the pixels of the image as belonging to a particular part of the hand or background. An example machine learning classifier based on a random decision forest is outlined below with reference to FIG. 5 to 7. Any other suitable image classifier can also be used.

In a further example, a motion capture system can be used, in which a marker is affixed to each of the points on the user's hand to be tracked (e.g. either affixed directly to the hand or on a glove). The marker can be made from retro reflective tape, and can be readily recognized in the captured image by the computing device 110, in order to determine the set of point locations.

Once the set of point locations on the user's hand 108 have been determined, the virtual representation 112 can be controlled 206 to reflect the position and pose of the user's real hand 108. Firstly, the equivalent points on the virtual representation 112 are positioned to match the set of point locations on the user's hand 108. For example, if the set of point locations comprises the fingertip locations and the wrist location, then the fingertips and wrist of the virtual representation are given corresponding locations in the virtual environment 102.

However, positioning these discrete points on the virtual representation 112 does not necessarily ensure that the virtual representation 112 mirrors the position and pose of the user's hand 108. For example, the joints of the virtual representation may bend at angles or locations that are not possible for real hands, and hence the virtual representation 112 may not accurately follow the hand pose of the user.

The configuration of the remaining parts (e.g. the jointed portions) of the virtual representation 112 is then implicitly computed using an inverse kinematics (IK) algorithm. An IK algorithm uses constraints in the possible movements of the joints (i.e. which directions they can bend, and to what extent). These constraints are derived from the possible motion of real hands. Given the set of point locations and the constraints, the IK algorithm works backwards to determine what position the jointed portions need to be in, in order for the set of point locations to be achieved.

An example of an IK algorithm that can be used is the Cyclic Coordinate Descent (CCD) algorithm. This IK algorithm performs an iterative heuristic search for each joint angle in order to reduce the distance of an end-effector (e.g. a virtual fingertip connected to other joint parts of the hand) to the goal (e.g. the tracked real point). Starting with the end-effector, each joint calculates its local minimum until the root of the joint chain is reached (e.g. wrist or shoulder). In other examples, different joint-solvers can also be used, such as provided by the Nvidia™ PhysX™ simulation framework, which provides a set of different types of joints (e.g. revolute joints, spherical joints, etc.). Further examples of IK algorithms include the Jacobian algorithm and the Jacobian Transpose algorithm.

Some IK algorithms can benefit from an initial calibration step. In an example initial calibration step the user extends the digits of their hand, and the camera captures an image of the contours of the hand and determines the length of the digits and/or each jointed portion.

The result of the IK algorithm is a pose and position for the virtual representation 112, which substantially matches the pose and position of the user's hand 108. This is achieved by only tracking a small number of points on the user's hand 108, e.g. five digit points plus one further point.

Note that in alternative examples, a different technique to an IK algorithm can be used to determine the position and pose of the virtual representation 112. For example, a set of exemplars can be stored and used to determine the position and pose of the virtual representation 112 for a given configuration of tracked points.

Once the position and pose of the virtual representation 112 has been determined, the computing device 110 can calculate the effect of the new position and pose on the virtual environment 102. In other words, the computing device 110 can determine whether there is interaction between the virtual representation 112 and one or more virtual objects 114, and control the display device 104 to update 208 the display of the virtual environment 102 in accordance with the interaction.

The interaction between the virtual representation 112 and the one or more virtual objects 114 is based on a physics simulation. The physics simulation models forces acting on and between the virtual representation 112 and the one or more virtual objects 114. These forces replicate the effect of equivalent forces in the real world, and make the interaction predictable and realistic for the user.

For example, collision forces exerted by the virtual representation 112 can be simulated, so that when the user moves their hand 108, and the virtual representation 112 moves correspondingly, then the effect of the virtual representation 112 colliding with any of the virtual objects 114 is modeled. This also allows virtual objects to be scooped up by the virtual representation of the user's hand.

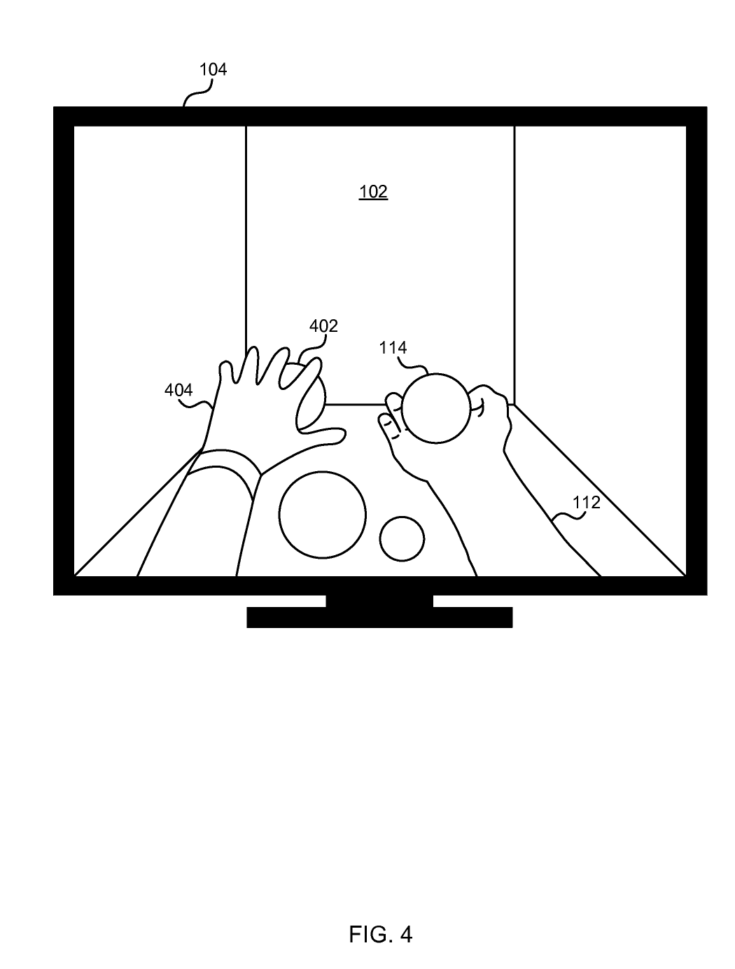

This is illustrated with reference to FIG. 4, which illustrates an example virtual environment 102 comprising two virtual representations 112 and 404 (corresponding to the right and left hands of the user), as displayed on display device 104. Virtual representation 112 is shown lifting a virtual object 114 by exerting a force underneath the object. Gravity can also be simulated so that the virtual object falls to the floor if released when lifted in the virtual environment 102.

Friction forces can also be simulated. This allows the user to control the virtual representation and interact with the virtual objects by grasping or pinching the objects. For example, as shown in FIG. 3, virtual representation 404 can grasp virtual object 402 and lift it or move it to another location. The friction forces acting between the digits of the virtual representation 404 and the side of the virtual object are sufficient to stop it from dropping. Friction forces can also control how the virtual objects slide over the surface of the virtual representation 404 or other surfaces in the virtual environment 102.

The virtual objects can also be manipulated in other ways, such as stretching, bending, and deforming, as well as operating mechanical controls such as buttons, levers, hinges, handles etc.

The above-described 3D user interaction technique therefore enables a user to control and manipulate virtual objects in a manner that is rich and intuitive, simply by using their hands as if they were manipulating a real object. This is achieved without excessive computational complexity by introducing a skeletal approximation of the user's hand into the 3D virtual environment, in which hand postures are simulated by positioning the hand's individual joints using an inverse kinematics algorithm, thereby using only a small number of tracked and updated points while the rest of the virtual representation's joints are configured automatically. This saves considerable computation resources compared to tracking and modeling the entire (constantly changing) shape and surface of the user's hand and introducing a fully fledged 3D mesh into the virtual environment.

Occlusion problems are also reduced when using a virtual representation and an IK algorithm. If a point on the user's hand is occluded, such that its location cannot be determined, then the IK algorithm ensures that the virtual representation does not assume an un-natural pose as a result of the missing information. In such cases, the occluded point can take its last known location, or revert to a default “resting” location relative to the surrounding points and meets the model's joint constraints.

This technique can also be extended as desired to enable the inclusion of further body parts. For example, the virtual representation can be extended to model the whole arm of the user based on minimal additional sensed input, such as a single tracked elbow point. The IK algorithm can be updated to take into account the movement constraints of the elbow and forearm/wrist joints, and can model the position of these joints with only the addition of the tracked elbow point.

The use of a physics-based simulation environment enables intuitive interactions with 3D virtual objects without the use of any additional processing for gesture detection or recognition. In other words, the computing device 110 does not need to use pre-programmed application logic to analyze the gestures that the user is making and translate these to a higher-level function. Instead, the interactions are governed by exerting collision and friction forces akin to the real world. This increases the interaction fidelity in such settings, for example by enabling the grasping of objects to then manipulate their position and orientation in 3D in ways a real world fashion. Six degrees-of-freedom manipulations are possible which were previously difficult or impossible when controlling the virtual environment using mouse devices, pens, joysticks or touch surfaces, due to the input-output mismatch in dimensionality.

Reference is now made to FIG. 5 to 7, which illustrate processes for training and using a machine-learning classifier for tracking the set of points on the user's hand from captured camera images. The machine learning classifier described here is a random decision forest. However, in other examples, alternative classifiers could also be used. In further examples, rather than using a decision forest, a single trained decision tree can be used (this is equivalent to a forest with only one tree in the explanation below).

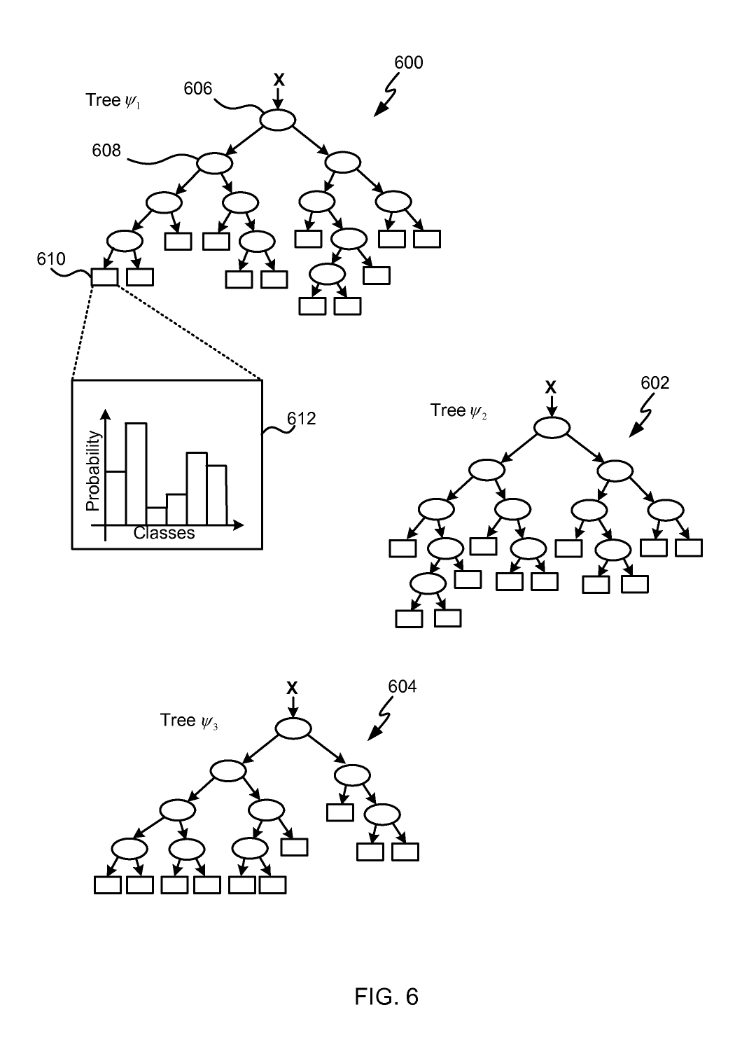

Before a random decision forest classifier can be used to classify image elements, a set of decision trees that make up the forest are trained. The tree training process is described below with reference to FIGS. 5 and 6.

FIG. 5 illustrates a flowchart of a process for training a decision forest to identify features in an image. The decision forest is trained using a set of training images. The set of training images comprise a plurality of images each showing at least one hand of a user. The hands in the training images are in various different poses. Each image element (e.g. pixel) in each image in the training set is labeled as belonging to a part of the hand (e.g. index fingertip, palm, wrist, thumb fingertip, etc.), or belonging to the background. Therefore, the training set forms a ground-truth database.

In one example, rather than capturing depth images for many different examples of hand poses, the training set can comprise synthetic computer generated images. Such synthetic images realistically model the human hand in different poses, and can be generated to be viewed from any angle or position. However, they can be produced much more quickly than real images, and can provide a wider variety of training images.

Referring to FIG. 5, to train the decision trees, the training set described above is first received 500. The number of decision trees to be used in a random decision forest is selected 502. A random decision forest is a collection of deterministic decision trees. Decision trees can be used in classification algorithms, but can suffer from over-fitting, which leads to poor generalization. However, an ensemble of many randomly trained decision trees (a random forest) yields improved generalization. During the training process, the number of trees is fixed.

The following notation is used to describe the training process. An image element in a image I is defined by its coordinates x=(x,y). The forest is composed of T trees denoted Ψ₁, . . . , Ψₜ, . . . , Ψ_{T} with t indexing each tree. An example random decision forest is shown illustrated in FIG. 6. The illustrative decision forest of FIG. 6 comprises three decision trees: a first tree 600 (denoted tree Ψ₁); a second tree 602 (denoted tree Ψ₂); and a third tree 604 (denoted tree Ψ₃). Each decision tree comprises a root node (e.g. root node 606 of the first decision tree 600), a plurality of internal nodes, called split nodes (e.g. split node 608 of the first decision tree 600), and a plurality of leaf nodes (e.g. leaf node 610 of the first decision tree 600).

In operation, each root and split node of each tree performs a binary test on the input data and based on the result directs the data to the left or right child node. The leaf nodes do not perform any action; they just store probability distributions (e.g. example probability distribution 612 for a leaf node of the first decision tree 600 of FIG. 6), as described hereinafter.

The manner in which the parameters used by each of the split nodes are chosen and how the leaf node probabilities are computed is now described. A decision tree from the decision forest is selected 504 (e.g. the first decision tree 600) and the root node 606 is selected 506. All image elements from each of the training images are then selected 508. Each image element x of each training image is associated with a known class label, denoted Y(x). The class label indicates whether or not the point x belongs to a part of the hand or background. Thus, for example, Y(x) indicates whether an image element x belongs to the class of a fingertip, wrist, palm, etc.

A random set of test parameters are then generated 510 for use by the binary test performed at the root node 606. In one example, the binary test is of the form: ξ>f(x; θ)>τ, such that f(x; θ) is a function applied to image element x with parameters 6, and with the output of the function compared to threshold values ξ and τ. If the result of f(x; θ) is in the range between ξ and τ then the result of the binary test is true. Otherwise, the result of the binary test is false. In other examples, only one of the threshold values ξ and τcan be used, such that the result of the binary test is true if the result of f(x; θ) is greater than (or alternatively less than) a threshold value. In the example described here, the parameter θ defines a visual feature of the image.

An example function ƒ(x; θ) can make use of the relative position of the hand parts in the images. The parameter θ for the function ƒ(x; θ) is randomly generated during training. The process for generating the parameter θ can comprise generating random spatial offset values in the form of a two-dimensional displacement (i.e. an angle and distance). The result of the function ƒ(x; θ) is then computed by observing the depth and/or intensity value for a test image element which is displaced from the image element of interest x in the image by the spatial offset.

This example function illustrates how the features in the images can be captured by considering the relative layout of visual patterns. For example, fingertip image elements tend to occur a certain distance away, in a certain direction, from the other fingertips and their associated digits but are largely surrounded by background, and wrist image elements tend to occur a certain distance away, in a certain direction, from the palm.

The result of the binary test performed at a root node or split node determines which child node an image element is passed to. For example, if the result of the binary test is true, the image element is passed to a first child node, whereas if the result is false, the image element is passed to a second child node.

The random set of test parameters generated comprise a plurality of random values for the function parameter θ and the threshold values ξ and τ. In order to inject randomness into the decision trees, the function parameters θ of each split node are optimized only over a randomly sampled subset Θ of all possible parameters. This is an effective and simple way of injecting randomness into the trees, and increases generalization.

Then, every combination of test parameter is applied 512 to each image element in the set of training images. In other words, all available values for θ(i.e. θᵢεΘ) are tried one after the other, in combination with all available values of ξ and τ for each image element in each training image. For each combination, the information gain (also known as the relative entropy) is calculated. The combination of parameters that maximize the information gain (denoted θ*, ξ* and τ*) is selected 514 and stored at the current node for future use. This set of test parameters provides discrimination between the image element classifications. As an alternative to information gain, other criteria can be used, such as Gini entropy, or the ‘two-ing’ criterion.

It is then determined 516 whether the value for the maximized information gain is less than a threshold. If the value for the information gain is less than the threshold, then this indicates that further expansion of the tree does not provide significant benefit. This gives rise to asymmetrical trees which naturally stop growing when no further nodes are beneficial. In such cases, the current node is set 518 as a leaf node. Similarly, the current depth of the tree is determined 516 (i.e. how many levels of nodes are between the root node and the current node). If this is greater than a predefined maximum value, then the current node is set 518 as a leaf node.

If the value for the maximized information gain is greater than or equal to the threshold, and the tree depth is less than the maximum value, then the current node is set 520 as a split node. As the current node is a split node, it has child nodes, and the process then moves to training these child nodes. Each child node is trained using a subset of the training image elements at the current node. The subset of image elements sent to a child node is determined using the parameters θ*, ξ* and τ* that maximized the information gain. These parameters are used in the binary test, and the binary test performed 522 on all image elements at the current node. The image elements that pass the binary test form a first subset sent to a first child node, and the image elements that fail the binary test form a second subset sent to a second child node.

For each of the child nodes, the process as outlined in blocks 510 to 522 of FIG. 5 are recursively executed 524 for the subset of image elements directed to the respective child node. In other words, for each child node, new random test parameters are generated 510, applied 512 to the respective subset of image elements, parameters maximizing the information gain selected 514, and the type of node (split or leaf) determined 516. If it is a leaf node, then the current branch of recursion ceases. If it is a split node, binary tests are performed 522 to determine further subsets of image elements and another branch of recursion starts. Therefore, this process recursively moves through the tree, training each node until leaf nodes are reached at each branch. As leaf nodes are reached, the process waits 526 until the nodes in all branches have been trained. Note that, in other examples, the same functionality can be attained using alternative techniques to recursion.

Once all the nodes in the tree have been trained to determine the parameters for the binary test maximizing the information gain at each split node, and leaf nodes have been selected to terminate each branch, then probability distributions can be determined for all the leaf nodes of the tree. This is achieved by counting 528 the class labels of the training image elements that reach each of the leaf nodes. All the image elements from all of the training images end up at a leaf node of the tree. As each image element of the training images has a class label associated with it, a total number of image elements in each class can be counted at each leaf node. From the number of image elements in each class at a leaf node and the total number of image elements at that leaf node, a probability distribution for the classes at that leaf node can be generated 530. To generate the distribution, the histogram is normalized. Optionally, a small prior count can be added to all classes so that no class is assigned zero probability, which can improve generalization.

An example probability distribution 612 is shown illustrated in FIG. 6 for leaf node 610. The probability distribution shows the classes c of image elements against the probability of an image element belonging to that class at that leaf node, denoted as Pₗ_{ₜ}₍ₓ₎(Y(x)=c), where lₜ indicates the leaf node l of the t^{th} tree. In other words, the leaf nodes store the posterior probabilities over the classes being trained. Such a probability distribution can therefore be used to determine the likelihood of an image element reaching that leaf node belonging to a given classification, as described in more detail hereinafter.

Returning to FIG. 5, once the probability distributions have been determined for the leaf nodes of the tree, then it is determined 532 whether more trees are present in the decision forest. If so, then the next tree in the decision forest is selected, and the process repeats. If all the trees in the forest have been trained, and no others remain, then the training process is complete and the process terminates 534.

Therefore, as a result of the training process, a plurality of decision trees are trained using synthesized training images. Each tree comprises a plurality of split nodes storing optimized test parameters, and leaf nodes storing associated probability distributions. Due to the random generation of parameters from a limited subset used at each node, the trees of the forest are distinct (i.e. different) from each other.

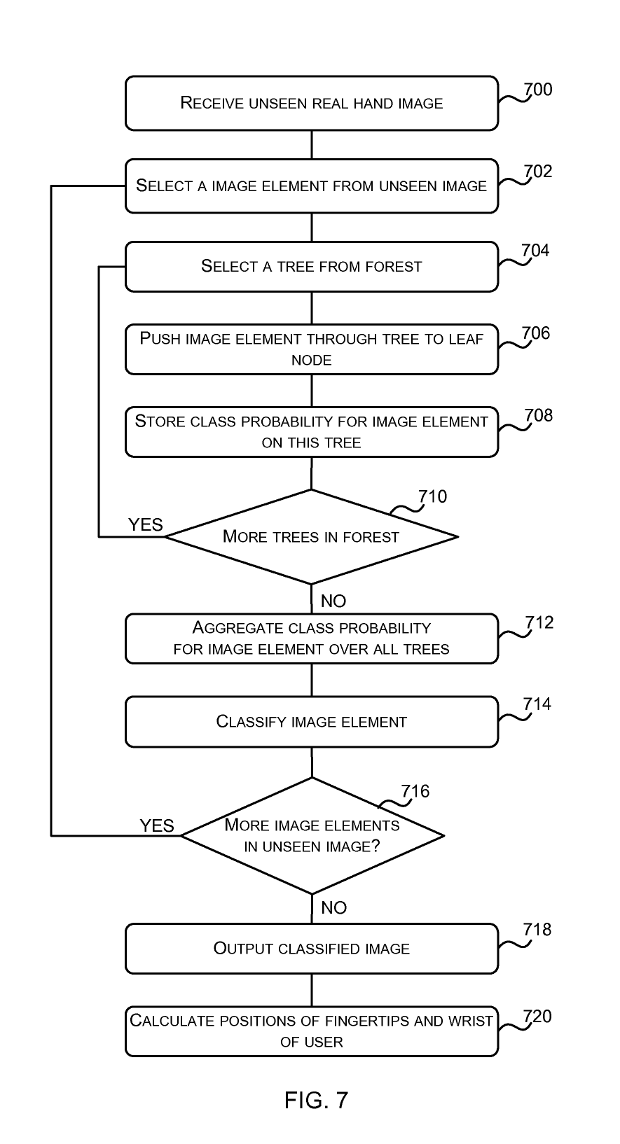

The training process is performed in advance of using the classifier algorithm to classify a real image. The decision forest and the optimized test parameters are stored on a storage device for use in classifying images at a later time. FIG. 7 illustrates a flowchart of a process for classifying image elements in a previously unseen image using a decision forest that has been trained as described hereinabove. Firstly, an unseen image of a user's hand (i.e. a real hand image) is received 700 at the classification algorithm. An image is referred to as ‘unseen’ to distinguish it from a training image which has the image elements already classified.

An image element from the unseen image is selected 702 for classification. A trained decision tree from the decision forest is also selected 704. The selected image element is pushed 706 through the selected decision tree (in a manner similar to that described above with reference to FIGS. 5 and 6), such that it is tested against the trained parameters at a node, and then passed to the appropriate child in dependence on the outcome of the test, and the process repeated until the image element reaches a leaf node. Once the image element reaches a leaf node, the probability distribution associated with this leaf node is stored 708 for this image element.

If it is determined 710 that there are more decision trees in the forest, then a new decision tree is selected 704, the image element pushed 706 through the tree and the probability distribution stored 708. This is repeated until it has been performed for all the decision trees in the forest. Note that the process for pushing an image element through the plurality of trees in the decision forest can also be performed in parallel, instead of in sequence as shown in FIG. 7.

Once the image element has been pushed through all the trees in the decision forest, then a plurality of classification probability distributions have been stored for the image element (at least one from each tree). These probability distributions are then aggregated 712 to form an overall probability distribution for the image element. In one example, the overall probability distribution is the mean of all the individual probability distributions from the T different decision trees. This is given by:

$$P ( Y ( x ) = c ) = \frac{1}{T} {\sum }_{t = 1}^{T} {P}_{{l}_{t} ( x )} ( Y ( x ) = c )$$

Note that methods of combining the tree posterior probabilities other than averaging can also be used, such as multiplying the probabilities. Optionally, an analysis of the variability between the individual probability distributions can be performed (not shown in FIG. 7). Such an analysis can provide information about the uncertainty of the overall probability distribution. In one example, the entropy can be determined as a measure of the variability.

Once the overall probability distribution is determined, the overall classification of the image element is calculated 714 and stored. The calculated classification for the image element is assigned to the image element for future use (as outlined below). In one example, the calculation of a classification c for the image element can be performed by determining the maximum probability in the overall probability distribution (i.e. P_{c}=maxₓP(Y(x)=c). In addition, the maximum probability can optionally be compared to a threshold minimum value, such that an image element having class c is considered to be present if the maximum probability is greater than the threshold. In one example, the threshold can be 0.5, i.e. the classification c is considered present if P_{c}>0.5. In a further example, a maximum a-posteriori (MAP) classification for an image element x can be obtained as c*=arg max_{c}P (Y(x)=c).

It is then determined 716 whether further unanalyzed image elements are present in the unseen depth image, and if so another image element is selected and the process repeated. Once all the image elements in the unseen image have been analyzed, then classifications are obtained for all image elements, and the classified image is output 718. The classified image can then be used to calculate 720 the positions of the set of point locations of the hand. For example, the central point of the image elements having the classification of ‘wrist’ can be taken as the point location for the wrist. Similarly, the mid-point of the image elements having the classification of ‘index fingertip’ can be taken as the point location for the index finger's fingertip, etc. This is then used as described above with reference to FIG. 2 to control the virtual representation 112.

Reference is now made to FIG. 8, which illustrates an example augmented reality system in which the 3D user interaction technique outlined above can be utilized. FIG. 8 shows the user 100 interacting with an augmented reality system 800. The augmented reality system 800 comprises the display device 104, which is arranged to display the 3D virtual environment as described above. The augmented reality system 800 also comprises a user-interaction region 802, into which the user 100 has placed hand 108. The augmented reality system 800 further comprises an optical beam-splitter 804. The optical beam-splitter 804 reflects a portion of incident light, and also transmits (i.e. passes through) a portion of incident light. This enables the user 100, when viewing the surface of the optical beam-splitter 804, to see through the optical beam-splitter 804 and also see a reflection on the optical beam-splitter 804 at the same time (i.e. concurrently). In one example, the optical beam-splitter 804 can be in the form of a half-silvered mirror.

The optical beam-splitter 804 is positioned in the augmented reality system 800 so that, when viewed by the user 100, it reflects light from the display device 104 and transmits light from the user-interaction region 802. Therefore, the user 100 looking at the surface of the optical beam-splitter can see the reflection of the 3D virtual environment displayed on the display device 104, and also their hand 108 in the user-interaction region 802 at the same time. View-controlling materials, such as privacy film, can be used on the display device 104 to prevent the user from seeing the original image directly on-screen. Hence, the relative arrangement of the user-interaction region 802, optical beam-splitter 804, and display device 104 enables the user 100 to simultaneously view both a reflection of a computer generated image (the virtual environment) from the display device 104 and the hand 108 located in the user-interaction region 802. Therefore, by controlling the graphics displayed in the reflected virtual environment, the user's view of their own hand in the user-interaction region 802 can be augmented, thereby creating an augmented reality environment.

Note that in other examples, different types of display can be used. For example, a transparent OLED panel can be used, which can display the augmented reality environment, but is also transparent. Such an OLED panel enables the augmented reality system to be implemented without the use of an optical beam splitter.

The augmented reality system 800 also comprises the camera 106, which captures images of the user's hand 108 in the user interaction region 802, to allow the tracking of the set of point locations, as described above. In order to further improve the spatial registration of the virtual environment with the user's hand 108, a further camera 806 can be used to track the face, head or eye position of the user 100. Using head or face tracking enables perspective correction to be performed, so that the graphics are accurately aligned with the real object. The camera 806 shown in FIG. 8 is positioned between the display device 104 and the optical beam-splitter 804. However, in other examples, the camera 806 can be positioned anywhere where the user's face can be viewed, including within the user-interaction region 802 so that the camera 806 views the user through the optical beam-splitter 804. Not shown in FIG. 8 is the computing device 110 that performs the processing to generate the virtual environment and controls the virtual representation, as described above.

The above-described augmented reality system can utilize the 3D user interaction technique to provide direct interaction between the user 100 and the graphics rendered in the virtual scene. In this example, the computing device 110 generates the virtual representation 112 of the user's hand 106, and inserts it into the virtual environment 102. However, the computing device 110 can optionally not render the virtual representation 112 on the display device 104. Instead, the effect of the virtual representation 112 is seen in terms of interaction with the virtual objects 114, but the virtual representation 112 itself is not visible to the user 100. However, the user's own hands are visible through the optical beam splitter 804, and by visually aligning the virtual environment 102 and the user's hand 108 (using camera 806) it can appear to the user 100 that their real hands are directly manipulating the virtual objects 114.

Reference is now made to FIG. 9, which illustrates various components of computing device 110. Computing device 110 may be implemented as any form of a computing and/or electronic device in which the processing for the 3D user interaction technique may be implemented.

Computing device 110 comprises one or more processors 902 which may be microprocessors, controllers or any other suitable type of processor for processing computing executable instructions to control the operation of the device in order to implement the 3D user interaction technique.

The computing device 110 also comprises an input interface 904 arranged to receive and process input from one or more devices, such as the camera 106. The computing device 110 further comprises an output interface 906 arranged to output the virtual environment 102 to display device 104 (or a plurality of display devices).

The computing device 110 also comprises a communication interface 908, which can be arranged to communicate with one or more communication networks. For example, the communication interface 908 can connect the computing device 110 to a network (e.g. the internet). The communication interface 908 can enable the computing device 110 to communicate with other network elements to store and retrieve data.

Computer-executable instructions and data storage can be provided using any computer-readable media that is accessible by computing device 110. Computer-readable media may include, for example, computer storage media such as memory 910 and communications media. Computer storage media, such as memory 910, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism. Although the computer storage media (such as memory 910) is shown within the computing device 110 it will be appreciated that the storage may be distributed or located remotely and accessed via a network or other communication link (e.g. using communication interface 908).

Platform software comprising an operating system 912 or any other suitable platform software may be provided at the memory 910 of the computing device 110 to enable application software 914 to be executed on the device. The memory 910 can store executable instructions to implement the functionality of a 3D virtual environment rendering engine 916, hand tracking engine 918 (e.g. comprising the machine learning classifier described above), virtual representation generation and control engine 920 (comprising the IK algorithms), as described above, when executed on the processor 902. The memory 910 can also provide a data store 924, which can be used to provide storage for data used by the processor 902 when controlling the interaction of the virtual representation in the 3D virtual environment.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of user interaction, comprising:
generating, on a processor, a virtual environment comprising one or more virtual objects and a virtual representation of a user's hand having virtual digits formed from a plurality of jointed portions, and displaying, on a display device, the one or more virtual objects;
tracking a point on each digit of the user's hand to obtain a set of point locations;
controlling the virtual representation such that each of the virtual digits have corresponding point locations to the user's hand, and using an algorithm to calculate positions for the plurality of jointed portions from the point locations; and
updating the one or more virtual objects displayed on the display device by simulating physical forces acting between the virtual representation and the one or more virtual objects in the virtual environment.

2. A method according to claim 1, wherein the point on each digit of the user's hand is a fingertip.

3. A method according to claim 1, wherein the algorithm comprises an inverse kinematics algorithm.

4. A method according to claim 1, wherein the virtual representation comprises a skeletal representation of a hand.

5. A method according to claim 1, wherein the step of tracking further comprises tracking a point on the user's wrist, such that the set of point locations further comprises the point on the user's wrist.

6. A method according to claim 1, wherein the step of tracking further comprises tracking a point on the user's palm, such that the set of point locations further comprises the point on the user's palm.

7. A method according to claim 1, wherein the step of tracking further comprises receiving a sequence of images of the user's hand from a camera, and analyzing the images to determine the set of point locations.

8. A method according to claim 7, wherein the step of analyzing comprises analyzing each image using a machine learning classifier to classify each portion of the image as belonging to at least one of: a fingertip, a palm; and a wrist.

9. A method according to claim 7, wherein each image is a depth image having a plurality of image elements, each image element having a value indicating a distance between the camera and a corresponding portion of the user's hand.

10. A method according to claim 1, wherein the step of tracking further comprises receiving data from a wearable position sensing device comprising position information for each of the user's digits.

11. A method according to claim 1, wherein the step of tracking further comprises receiving a sequence of images of the user's hand from a camera, wherein the point on each digit of the user's is identified with a marker in each image, and analyzing the marker locations to determine the set of point locations.

12. A method according to claim 1, wherein the step of displaying further comprises displaying the virtual representation on the display device.

13. A method according to claim 1, wherein the step of simulating physical forces comprises simulating at least one of: friction; gravity; and collision forces between the virtual representation and the one or more virtual objects.

14. A method according to claim 13, wherein the simulated friction between the virtual representation and the one or more virtual objects enables the one or more virtual objects to be grasped between the virtual digits and lifted in the virtual environment.

15. An interactive computer graphics system, comprising:
a processor arranged to generate a virtual environment comprising one or more virtual objects and a virtual representation of a user's hand having virtual digits formed from a plurality of jointed portions;
a display device arranged to display the one or more virtual objects; and
a camera arranged to capture images of the user's hand,
wherein the processor is further arranged to use the images of the user's hand to track a point on each digit of the user's hand to obtain a plurality of point locations, control the virtual representation such that each of the virtual digits have corresponding point locations to the user's hand, use an inverse kinematics algorithm to calculate positions for the plurality of jointed portions from the point locations, and control the display device to update the one or more virtual objects displayed on the display device by simulating physical forces acting between the virtual representation and the one or more virtual objects in the virtual environment.

16. A system according claim 15, wherein the camera is a depth camera arranged to capture images having a plurality of image elements, each image element having a value indicating a distance between the camera and a corresponding portion of the user's hand.

17. A system according claim 16, wherein the depth camera comprises at least one of: a time-of-flight camera; a stereo camera; and a structured light emitter.

18. A system according claim 15, further comprising an optical beam splitter positioned so that light from the display device is reflected to the user, whilst allowing the user to look through the optical beam splitter at the user's hand, and the processor is arranged to visually align the virtual representation of the user's hand as reflected on the optical beam splitter with the user's hand as viewed through the optical beam splitter.

19. A system according claim 15, wherein the display device comprises at least one of: a stereoscopic display, an autostereoscopic display, a volumetric display, and a head-mounted display.

20. One or more tangible device-readable media with device-executable instructions that, when executed by a computing device, direct the computing device to perform steps comprising:
generating a 3D virtual environment comprising one or more virtual objects and a virtual representation of a user's hand having virtual digits formed from a plurality of jointed portions;
controlling a display device to display the one or more virtual objects and the virtual representation of the user's hand;
receiving a sequence of images from a depth camera;
analyzing the sequence of images using a computer vision algorithm to track a fingertip of each digit of the user's hand and a point on the wrist of the user's hand to obtain a set of point locations;
controlling the virtual representation such that each of the virtual digits have corresponding point locations to the user's hand, and using an inverse kinematics algorithm to calculate positions for the plurality of jointed portions from the point locations; and
updating the one or more virtual objects displayed on the display device by simulating collision and friction forces acting between the virtual representation and the one or more virtual objects in the 3D virtual environment.
